(19) United States
(12) Patent Application Publication
(10) Pub. No.: US 2023/0132004 A1
(43) Pub. Date: Apr. 27, 2023

(54) SYSTEMS AND METHODS TO REDUCE NOISE IN A GROUP OF ELEMENTS

(71) Applicant: GUMMAGATTA NARYANAREDDY SRIKANTH, Bangalore (IN)

(72) Inventor: GUMMAGATTA NARYANAREDDY SRIKANTH, Bangalore (IN)

(21) Appl. No.: 17/707,961

(22) Filed: Mar. 30, 2022

Related U.S. Application Data
(60) Provisional application No. 63/271,238, filed on Oct. 25, 2021.

(51) Int. Cl. G06N 5/02

(52) U.S. Cl. CPC G06N 5/02

(57) ABSTRACT

In one aspect, a method of forming a plurality of elements with tagentiblity and hierarchy properties, the method comprising the steps of: building a set of knowledge representations wherein the step of building the set of knowledge representations further comprises: wherein the plurality of elements are extracted from a domain information and are a meaning the domain information; associating each individual elements of the plurality of elements into a grouping of elements using a plurality of attributes comprising an implicit attribute and an explicit attributes, utilizing a plurality of knowledge sources and a plurality of complimentary knowledge sources that prior collected prior in an incremental manner, and associating the plurality of elements of claim into the plurality of knowledge sources using a relevancy technique; applying a feedback optimization technique to the plurality of knowledge sources; decreasing a relevancy attribute weights of the plurality of attributes by a decay on a negative feedback on elements; increasing the relevancy attribute weights of the plurality of attributes by a decay on positive feedback on the plurality of elements; and finding a set of differing attributes and increasing the relevancy attribute weights of the set of differing attributes by a decay on substitution feedback on the plurality of elements.

### CLAIM OF PRIORITY

This application claims priority to U.S. Provisional Application No. 63/271,238, filed on 25 Oct. 2021 and titled SYSTEMS AND METHODS TO REDUCE NOISE IN A GROUP OF ELEMENTS. This provisional application is hereby incorporated by reference in its entirety.

### BACKGROUND

In the current state of recommendation systems, there has not been significant work in reducing the noise in a group of recommended items. Algorithms such as association mining can provide a probabilistic bundle of items which are bought together but they are susceptible to noise in the data. If noise is present in the training data, the same noise will be recommended as part of the recommendations. The existing techniques suffer from lack of training data, enough data, missing data, patterns in user behavior etc. and hence are bound by the input data. The proposed method helps to reduce the noise in the output of such systems. This improves the quality of recommendations in turn increases the revenue for the organization.

### SUMMARY OF THE INVENTION

In one aspect, a method of forming a plurality of elements with tagentiblity and hierarchy properties, the method comprising the steps of: building a set of knowledge representations wherein the step of building the set of knowledge representations further comprises: wherein the plurality of elements are extracted from a domain information and are a meaning the domain information; associating each individual elements of the plurality of elements into a grouping of elements using a plurality of attributes comprising an implicit attribute and an explicit attributes, utilizing a plurality of knowledge sources and a plurality of complimentary knowledge sources that prior collected prior in an incremental manner, and associating the plurality of elements of claim into the plurality of knowledge sources using a relevancy technique; applying a feedback optimization technique to the plurality of knowledge sources; decreasing a relevancy attribute weights of the plurality of attributes by a decay on a negative feedback on elements; increasing the relevancy attribute weights of the plurality of attributes by a decay on positive feedback on the plurality of elements; and finding a set of differing attributes and increasing the relevancy attribute weights of the set of differing attributes by a decay on substitution feedback on the plurality of elements.

### BRIEF DESCRIPTION OF THE DRAWINGS

FIG. 1 illustrates an example schematic view of an element used for reducing noise in a group of elements, according to some embodiments.

FIG. 2 illustrates an example schematic view describing what is a grouped element, according to some embodiments.

FIG. 3 illustrates an example process to reduce noise in a group of elements, according to some embodiments.

FIG. 4 illustrates an example process for how the knowledge backing and/or complementary domain backing is built, according to some embodiments.

FIG. 5 illustrates an example optimization process implemented across a user interaction, according to some embodiments.

FIG. 6 illustrates an example process for traversal, according to some embodiments.

FIG. 7 illustrates an example process for implementing a relevancy technique, according to some embodiments.

FIG. 8 illustrates an example process of a technique, according to some embodiments.

FIG. 9 depicts an exemplary computing system that can be configured to perform any one of the processes provided herein.

FIG. 10 illustrates an example process for describing the relevancy method between source and destination element, according to some embodiments.

The Figures described above are a representative set and are not an exhaustive with respect to embodying the invention.

### DESCRIPTION

Disclosed are a system, method, and article of manufacture of reducing noise in a group of elements. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method.

Additionally, the order in which a particular method occurs may or may not strictly adhere to the order of the corresponding steps shown.

### Definitions

Example definitions for some embodiments are now provided.

Application programming interface (API) is an interface or communication protocol between a client and a server intended to simplify the building of client-side software.

Cloud computing can involve deploying groups of remote servers and/or software networks that allow centralized data storage and online access to computer services or resources. These groups of remote serves and/or software networks can be a collection of remote computing services.

Natural language processing (NLP) is a subfield of linguistics, computer science, and artificial intelligence concerned with the interactions between computers and human language, in particular how to program computers to process and analyze large amounts of natural language data.

Feedback optimization is a function that aggregates the different levels of positive, negative, and other forms of feedback across multiple users and items in a recommendation system. Example feedback optimization techniques used herein can include, inter alia: feedback optimization technique can include, inter alia: a weighted mean technique, a regression technique, a constrained optimization technique, etc. It is noted that feedback can be implicit and/or explicit.

Example Systems and Methods

Example methods utilize the natural language present in an information/entity description and determine the noise among the group of entities. Example methods utilize NLP and graphs when it comes to recommendation/grouping/categorization systems. Example method identify elements wherein the unnecessary elements present in a group of or thereby part of relationship. The element thereby reduces the quality of the grouping giving rise to bad/poor experience to the users consuming the system.

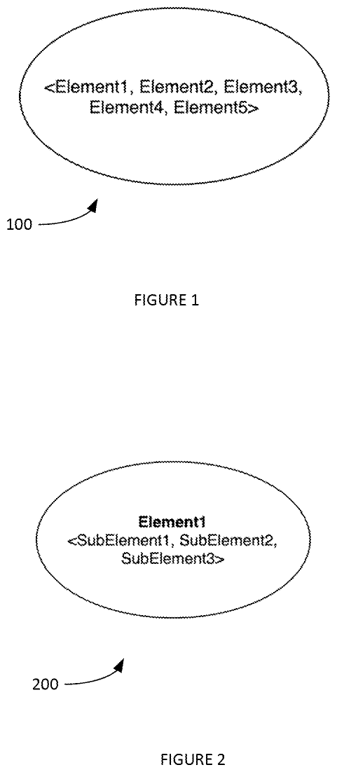

FIG. 1 illustrates an example schematic view of an element 100 used for reducing noise in a group of elements, according to some embodiments. FIG. 2 illustrates an example schematic view 200 describing what is a grouped element, according to some embodiments. An element can be a tangible entity or intangible entity. Examples of tangible entities include shirt, pants, car, house which can be perceived physically with our human senses. Examples of intangible entities can be concepts (e.g. electro-magnetism), trends (e.g. fashion trends), emotions (e.g. happy, sad), etc.

Elements can be independent entities or have associations with other entities. The associations can be between materialistic entities or intangible entities or tangible and intangible elements. Quantum mechanics, electromagnetism are tangible entities that have a hierarchical association with the intangible element physics. Biscuits, chips are tangible elements with a part of association with tangible element snacks. Mobile phones, electronics, touch tablets are tangible entities that have a part of association with the intangible element category of electronic gadgets. Hierarchy properties can define a part of relationships (e.g. Earth is part of a solar system), parent child relationships (California state is in the USA country), etc.

Three example aspects in determining the relevancy can be:

Attribute of the elements;

A priori or knowledge or experience of the user;

Context of the element and/or the user; and

Domains of knowledge backing.

The different knowledge backings are the representations of the same element in different domains. This helps to deem relevancy with respect to the user considering the various different types of knowledge representation in the head of different users.

For example, for a teenager can have a representation of a car in his mind, the teenager may describe the car as fast, sporty, powerful, flashy, and causes an adrenaline rush. In contrast, an old person can have another representation of a car is, the older person may describe the car as a means to travel from point A to point B with good mileage and comfort. The same element car is represented in different ways in different user's heads. If an e-commerce website is selling secondhand cars, the user representation of the element becomes important because what is a relevant car for teenagers may not be a relevant car for an old person.

The attributes of the element or meta might be already present in the origin or can be derived. In the further aspect of the method attributes can be implicit or explicit. Explicit attributes are present on the element. It can be meta information about the element. Implicit attributes are the attributes which are derived from the elements. Example, in the case of a paragraph in the book, the system can know the meta information of the type of element which book, which chapter it is from and/or the author of the book. But the top keywords in a paragraph are derived attributes which the system can explicitly compute or extract from the text.

Whether the item is deemed irrelevant (e.g. noise) or not is usually determined by the domain experts who have a priori or knowledge. In the case of books in a library, the system can place a C++ book among a collection of Java books. The domain expert over here, the library shelving assistant, finds that the Java book doesn't belong to the C++ book collection and takes it from outside this bookshelf and/or places it among the Java collection of books. Here the person might ascertain this domain knowledge from the person's personal knowledge or by looking at the book ID which infers the right shelf number for the book. Therefore the domain knowledge also matters in redeeming the noise in the system.

In another aspect of the system, context of the element and the users also deem an important part in redeeming the noise in a system. It is the environment where something can exist. Context applies both to the users of the system and the element themselves. Context can be temporal, spatial, behavioral, or socio-economic factors. Thereby it is important to consider context in redeeming noise.

### Example 1

An embodiment can show a low-income person a plain Gucci black color belt and with a bunch of similar looking generic non-branded belts, the person might deem both the belts relevant. In another example, a higher income person can have both of the belts, the person might deem the costlier, designer belt a noise between the cheaper non-branded belts. Here the socio-economic factor is the context in redeeming the noise.

### Example 2

Fashion (trend element) which was present 20 years ago, may not be considered relevant in the current age. For example, pairing bright colored shirts with equally contrasting bright color pants was in vogue in the 1970s but may not be relevant right now. Here the context is temporal.

### Example 3

In one example, the Bollywood movie, Singham, the actor Ajay Devgn (person) and/or the police role (character) is deemed relevant. Here the context is spatial and/or within the run-time of the movie. This can refer to both of the elements (police and/or Ajay Devgn) outside the frame of the movie, in the real world, it might be difficult to call them both relevant.

According to one aspect of the method, the input entities where the noise has to be determined can be a single group at the top level or several subgroups of lower-level entities. Further at least one such group or subgroup consisting of entities are formed based on one or several attributes.

According to further aspect of the method, a general set of entities are extracted from domain(s) information which could be a combination of several text files, image files etc. These extracted entities are used to create a domain-entity dictionaries of domain-entity graphs or a knowledge graph. Such, dictionary, or graph shall have a provision to look up or traverse to an entity based on attributes, retrieve meta information, and calculate distance with respect to the relationship in the form of edges or lookup iterations etc.

According to further aspect of the method, a complementing domain graph or dictionary or knowledge graph is created which helps to understand entities that complement each other that may not be relevant to each other.

### Example 1

Scissors and tape may not be similar in case of functionality or appearance but they are used to obtain her. In an e-commerce domain selling both of these products, it becomes important to consider these element similar because they make up for a good frequently bought to obtain her recommendations.

The different knowledge backings are the representations of the same element in different domains. This helps to deem relevancy with respect to the user considering the various different types of knowledge representation in the head of different users.

### Example 1

For a teenager, the system can ask what is the representation of a car in his mind, he would say the car is fast, sporty, powerful, flashy, obtains the adrenaline rushing. If the system can ask an old person what a car is, he would say the car move one from point A to point B, mileage is important in a car, comfort is another important aspect of the car. The same element car is represented in different ways in different user's heads. If a user has an e-commerce website selling secondhand cars, the user representation of the element becomes important because what is a relevant car for teenagers may not be a relevant car for an old person.

A relevancy technique is defined depending on the type of element defined.

### Example 1

If the element contains text the system can look at NLP techniques like TF-IDF, count vectorizer, embedding similarity to ascertain the relevancy of the attributes.

### Example 2

If the element contains an image, video the system can look at image similarity techniques like overlapping EXIF data and/or similarity metrics over embeddings using the product attributes.

Here the relevancy techniques are not limited to the ones mentioned over here and this is not an exhaustive list.

According to further aspect of the method, several pairs are formed from the entities present in the above-mentioned groups. Next, each such entity is mapped or associated with the above-mentioned information graph. Next, Iteratively several operations are performed on each such identified pair.

In one operation the first entity of the pair is identified as the source and second entity as the destination. Next, the system can lookup or accordingly traverse the edges from the source to destination and record the relevancy of the attributes to the source using the domain specific relevancy techniques.

In another operation a lookup operation and/or accordingly traversal of the edges from the destination to source and record the relevancy of the attributes to the source using the domain specific relevancy techniques.

In another operation the relevancy of the source and destination is determined by applying optimization techniques which captures the relevancy change during the multiple traversals or lookups. Relevancy change could be based on one or more parameters related to the domain like the number of paths associated, the number of edges etc.

In another operation that may be linked to previous operation the system can mark the source and destination as deemed relevant.

In another operation the system can finally discard the irrelevant elements in the grouping thereby reducing the noise in the system.

According to another aspect of the method the domain relevancy is measured against the complimenting domain to arrive at the complimenting relevancy.

According to another aspect of the method, relevancy and complimenting relevancy scores are tracked across users to arrive at an error threshold by employing machine learning or deep learning techniques. Here the system can look at the scores across different users having the similar grouping to come up with it. The interaction of the user with the said grouping is considered. Here both the negative and/or positive feedback from the user is fed back into the optimization technique to decide on whether the grouping is valid or not. In the further aspect of the method feedback can be implicit or explicit. The attributes of the item removed and the attribute of the item added are compared to understand which attributes are different and it will be given more weightage in the next iteration of the comparison of items in the complimentary domain.

### Example 1

In a video in a playlist, if the user dislikes one of the items in the grouping by or removes any videos in the playlist this is considered as negative feedback. At the same time, if the user likes any video in the playlist or leaves a positive comment such as “I love the video!” it is considered as positive feedback. The sentiment in case of NLP text can be inferred. Here the explicit interactions are liking, leaving comments, adding to favorite list. The implicit interaction would be watching the full video, rewatching the video multiple times.

### Example 2

In an e-commerce cart, if the user removes an item from a pre-aggregated recommended group of items for example removing AA battery and/or adding AAA battery for electric toothbrush supporting only AAA battery, this is a negative explicit feedback. Here even though the type of the products are the same, the size of the battery differs. The size attribute is given more emphasis on the next iteration of the pairwise comparison of items in the similar category.

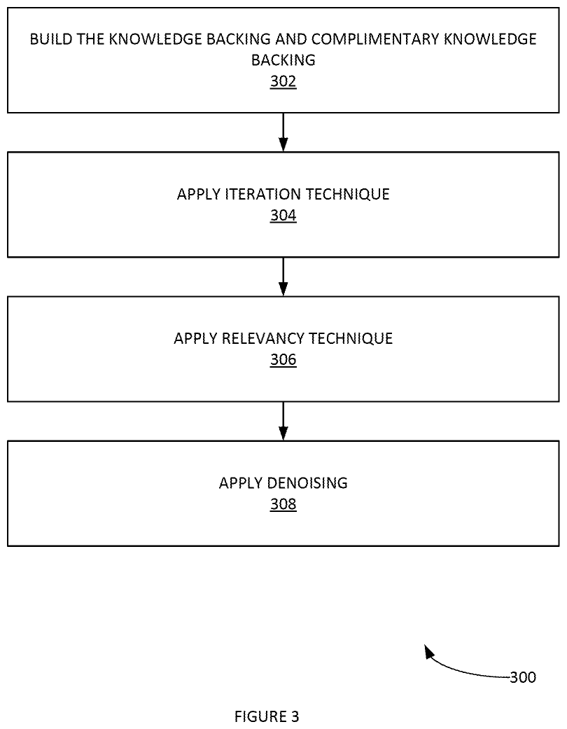

FIG. 3 illustrates an example process 300 to reduce noise in a group of elements, according to some embodiments. In step 302, process 300 builds the knowledge backing or dictionary of elements. For each element collected, process 300 extracts the implicit and explicit attributes described in the summary of the invention. The elements are constructed into independent elements or arranged underneath each element such that element is a logical grouping constructed within the element in step 304. This grouping can be determined by the aspect of implicit or explicit attributes described in the below section. Here each element may have one or many associations with other elements. This can be done by bootstrapping knowledge sources. Knowledge sources can be obtained from previously available sources or collected incrementally. Associate the elements to the knowledge source using relevancy techniques and collect all complementary domains in step 306. Process 300 can store this knowledge structure.

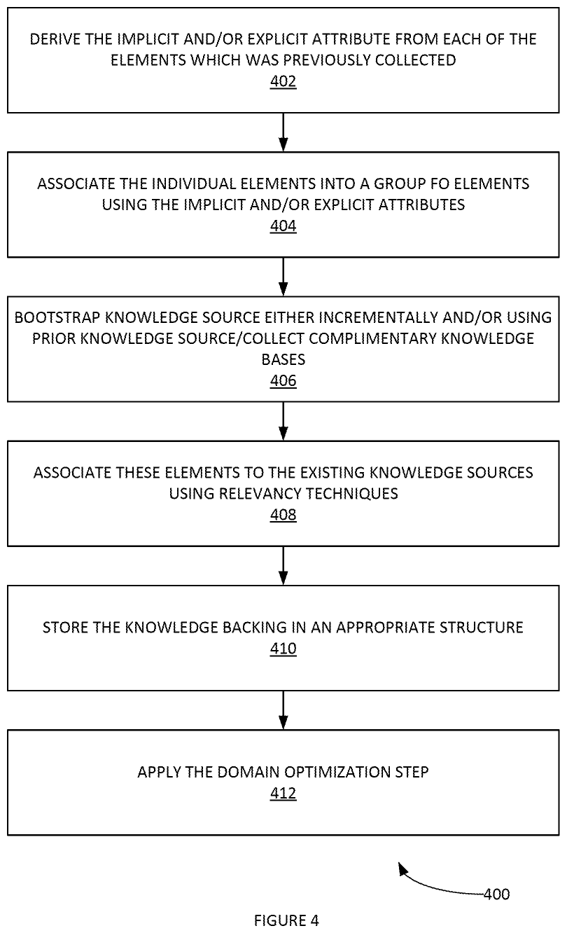

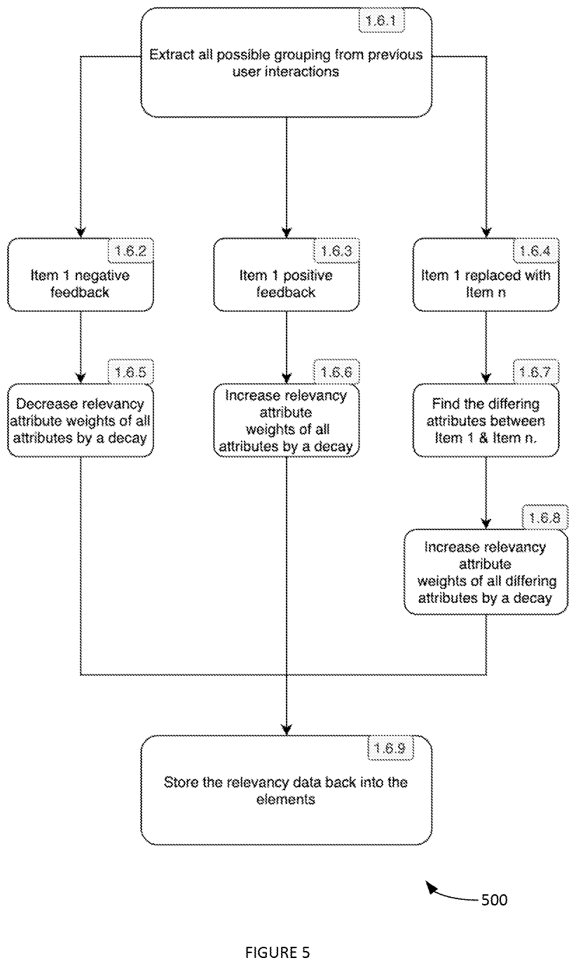

FIG. 4 illustrates an example process 400 for how the knowledge backing and/or complementary domain backing is built, according to some embodiments. In step 402, process 400 can derive the implicit and/or explicit attribute from each of the elements which was previously collected. In step 404, process 400 can associate the individual elements into a group of elements using the implicit and/or explicit attributes. In step 406, process 400 can bootstrap knowledge source either incrementally and/or using prior knowledge source/collect complimentary knowledge bases. In step 408, process 400 can associate these elements to the existing knowledge sources using relevancy techniques. In step 410, process 400 can store the knowledge backing in an appropriate structure. In step 412, process 400 can apply the domain optimization step.

FIG. 5 illustrates an example optimization process 500 implemented across a user interaction, according to some embodiments. The process of the feedback described in is applied to fine-tune the representations of information borne within the elements and the associated structures. The optimization technique bootstraps the relevancy weights for each attribute of an element. This association is collected across users or manually curated with the tag saying whether the grouping is relevant or irrelevant. If the grouping is relevant each of the attributes is assigned equal weights. The user interaction of being implicit or explicit is received and it is applied to the attribute weights.

If the element has a negative feedback, this means the element is probably a noise in the grouping, then the system can reduce the attribute weights by a decay factor conversely if the element has a positive feedback, this means the element is relevant to the grouping, then process 500 can increase the attribute weights by an increment factor. If the element was replaced (e.g. a remove followed by an addition to the same grouping) this means the element is noise and the added item was a substitute for it, then process 500 can increment the attribute weights of the differing attributes. Then process 500 can store the relevancy data back into the elements.

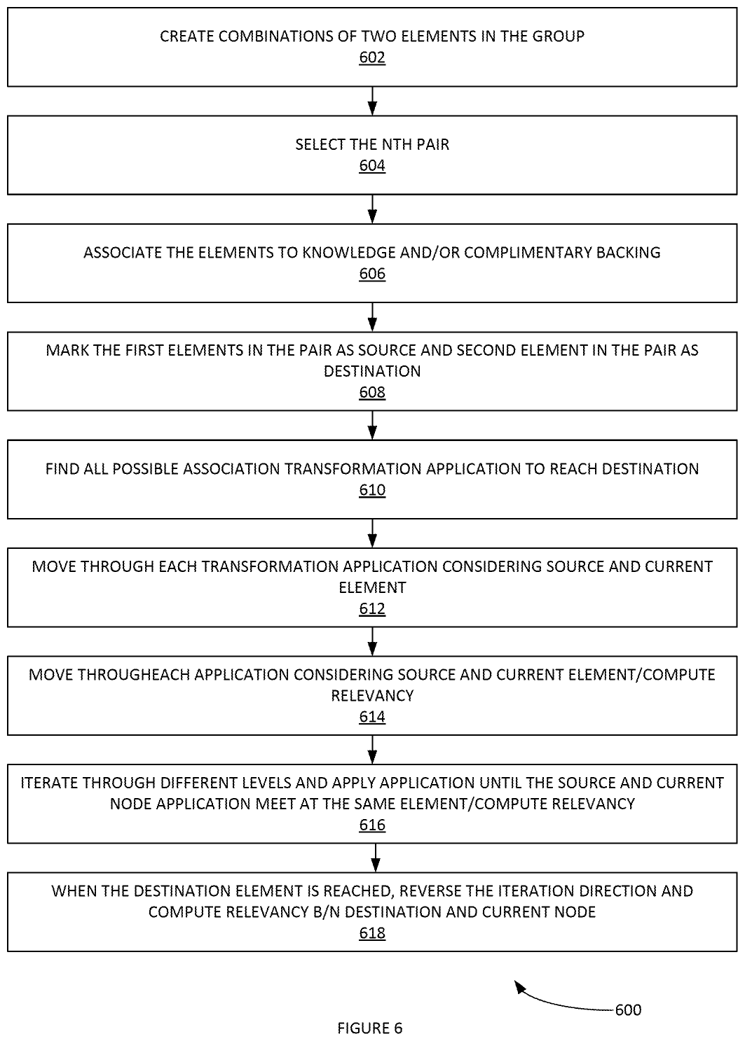

FIG. 6 illustrates an example process 600 for traversal, according to some embodiments. The process of iteration begins within the group. Process 600 can create all possible pairwise combinations present in the group in step 602. Process 600 can select the nth pair in step 604 and associate in step 606 the elements to knowledge and/or complementary backing. Process 600 can mark the first element in the pair as source and second element in the pair as destination in step 608. Process 600 can then find all possible association transformation applications to reach destination in step 610. Process 600 can then iterate through each transformation application considering source and current element in step 612. Then the relevancy is computed.

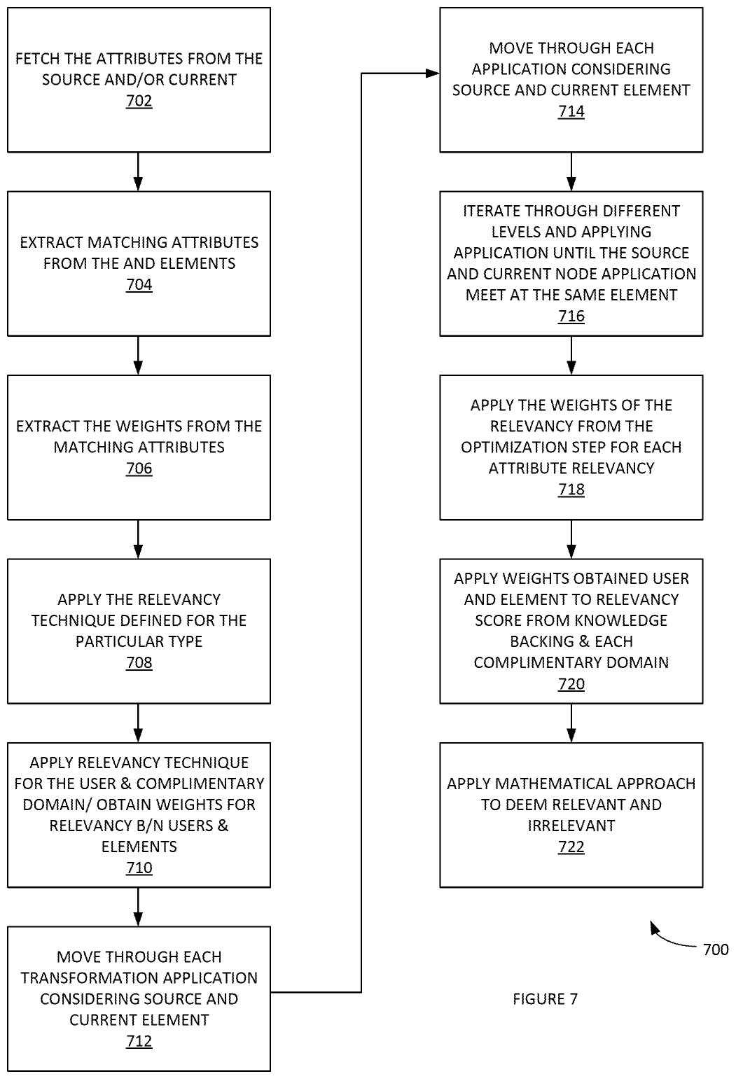

FIG. 7 illustrates an example process 700 for implementing a relevancy technique, according to some embodiments. For computing relevancy, process 700 can fetch the attributes from the source and current element in step 702. Process 700 can extract matching attributes from the user and elements so that process 700 can consider the context described in the summary of the invention in step 704. Process 700 can extract the weights from the matching attributes which was optimized (e.g. see FIG. 4, etc.). Process 700 can apply the relevancy technique defined for that particular type of element in step 708. Examples of such relevancy techniques are described herein.

Process 700 can apply the aforementioned relevancy between user and the complementary domain in step 710. This is done to consider the aspect of representation of the same elements in complementary knowledge domains. Process 700 can prove through each transformation application considering source and/or current element in step 712. The relevancy is also applied to all levels of associations where the same process of the aforementioned iteration is applied in step 714. The higher levels and lower levels of associations might be a part of the relationship mentioned in the above summary of the invention in step 716. This encapsulates the element relevancy at the higher order. Overall, the association is applied to multiple dimensions. Also this takes care if the element contains very less information about itself or if the element attributes themselves may contain a lot of noise. Thereby Process 700 can obtain relevancy at different levels of associations for a single element with respect to the source element. Process 700 can traverse the levels of relevance in different directions until process 700 encounters a common element or end of the association. Process 700 can apply the weights of relevancy from the optimization step for each attribute relevance which accounts for domain level knowledge given by the knowledge backing in step 718. Process 700 can apply the overall relevancy score obtained with respect to the complimentary domain and/or knowledge backing so that process 700 can account for the different representations of elements in step 720. Process 700 can apply a mathematical approach to deem relevant or irrelevant elements in step 722 which may contain extracting characteristics from the relevancy list. Examples of such mathematical approaches may be included such as, inter alia: Cosine similarity, Jaccard similarity applied on the extracted embeddings of the vector space or eigenvectors, etc.

Returning to process 600, process 600 can traverse the association and every element process 600 may encounter is subject to the relevancy technique with respect to the source element in step 614. Process 600 can iterate and/or apply at different levels so noisy attributes are also taken care of in step 616. Process 600 can apply the same technique with respect to the destination element of step 618 by reversing the iteration direction and computing relevance between the destination and current node.

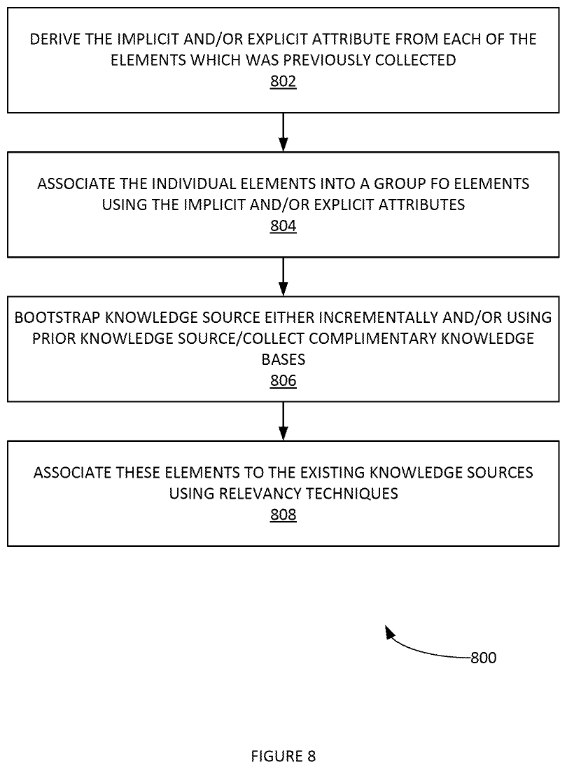

FIG. 8 illustrates an example process 800 of a technique, according to some embodiments. Process 800 can then collect all stored markings of relevant and/or irrelevant in step 802 for each element pair. Process 800 can aggregate the relevancy scoring positive value in step 804 for relevant pair and/or negative value in step 806 for irrelevant pair. Process 800 can then perform a selection technique to select the top relevant elements in the grouping in step 808. Finally, process 800 can perform an aggregation operation and apply a selection technique to determine the top n relevant elements from the group of elements.

### ADDITIONAL EXAMPLE USE CASES

### Example 1

In a market basket analysis, the system might have irrelevant items in a basket. Sometimes, customers might buy soap with bread which cannot be of logical grouping but more of by chance, it is to obtain her. This in turn degrades the quality of recommendation when the system can apply association mining where the system can reuse this association or combination for another customer.

### Example 2

People might enter irrelevant sentences, words into forms relating to registration, feedback etc. which doesn't give proper feedback to the concerned entity.

### Example 3

In a bookstore, the system can arrange the books on the shelves based on topics and the members might put irrelevant books which are not pertaining to the same topic. This frustrates the other members in the library because they are not able to find the relevant book in the correct shelf and/or also come across irrelevant books in the shelf.

Additional Systems and Architecture

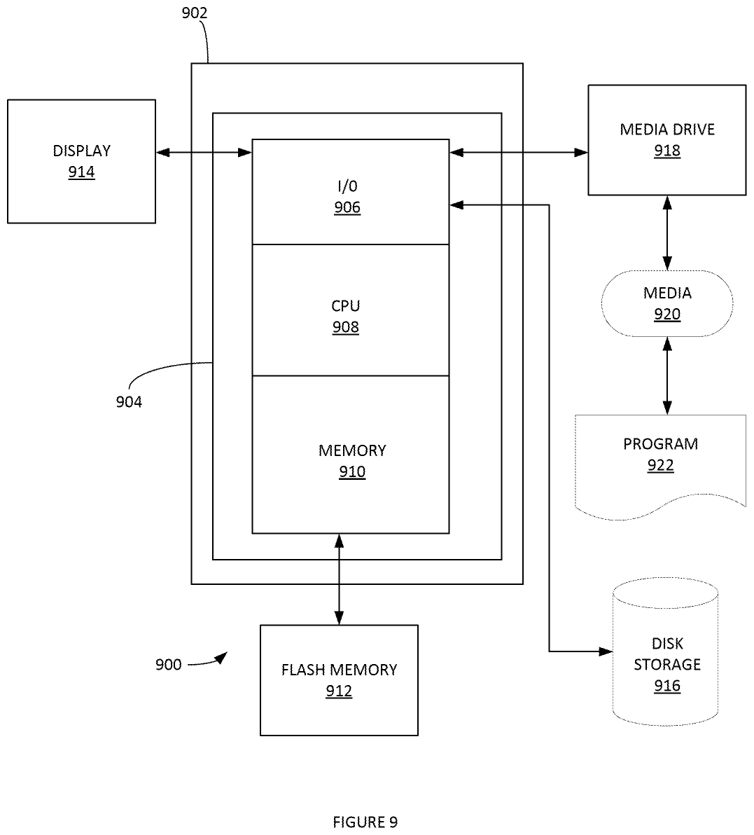

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. Computing system 900 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

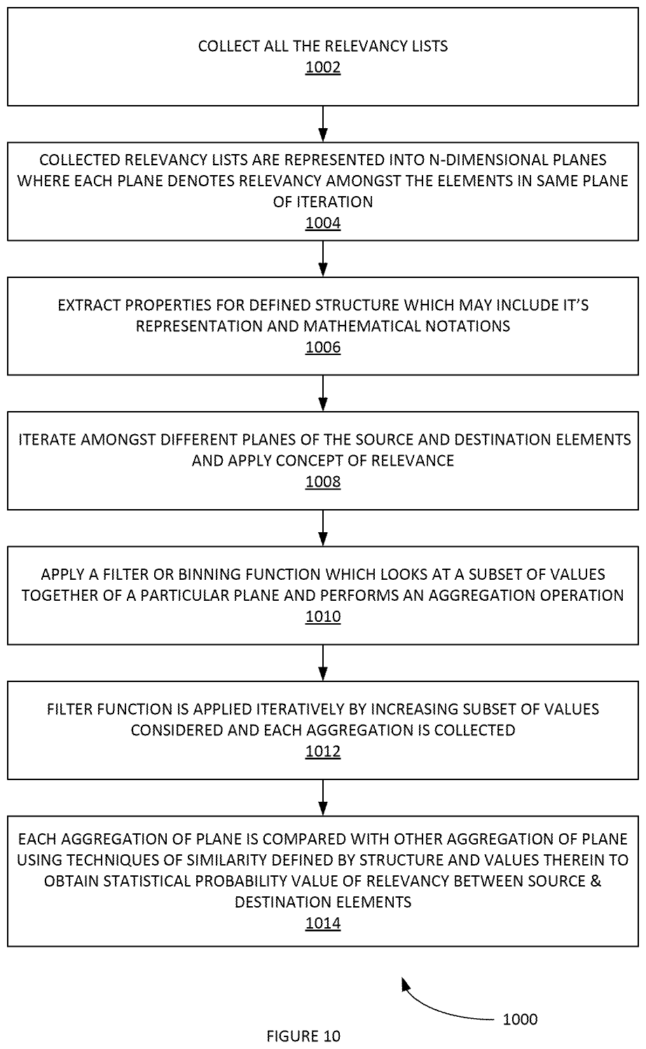

FIG. 10 illustrates an example process 1000 for describing the relevancy method between source and destination element, according to some embodiments. This section describes the relevancy technique applied for a source and destination elements. Process 1000 collects all the relevancy lists in step 1002.

The collected relevancy lists are represented into n-dimensional planes where each plane denotes relevancy amongst the elements in the same plane of iteration in step 1004. For this relevancy process 1000 extracts properties for the defined structure which may include it's representation and mathematical notations in step 1006. Representation may include the dimensions in each axis and mathematical notations include eigen vectors, sparse matrix representations etc. Each slice of the n-th dimension, process 1000 performs the comparison between the aforementioned properties which might include applying mathematical concepts or physics concepts.

Process 1000 iterates amongst different planes of the source and destination elements and apply the concept of relevance in step 1008. In the concept of relevance, process 1000 applies a filter or binning function which looks at a subset of values together of a particular plane and performs an aggregation operation 1010. The filter function is applied iteratively by increasing the subset of values considered and each aggregation is collected in step 1012. Then each aggregation of a plane is compared with the other aggregation of the plane using techniques of similarity defined by the structure and values therein to obtain a statistical probability value of relevancy between source and destination elements 1014.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of forming a plurality of elements with tagentiblity and hierarchy properties, the method comprising the steps of:
building a set of knowledge representations wherein the step of building the set of knowledge representations further comprises:
wherein the plurality of elements are extracted from a domain information and are a meaning the domain information;
associating each individual elements of the plurality of elements into a grouping of elements using a plurality of attributes comprising an implicit attribute and an explicit attributes,
utilizing a plurality of knowledge sources and a plurality of complimentary knowledge sources that prior collected prior in an incremental manner, and
associating the plurality of elements of claim into the plurality of knowledge sources using a relevancy technique;
applying a feedback optimization technique to the plurality of knowledge sources;
decreasing a relevancy attribute weights of the plurality of attributes by a decay on a negative feedback on elements;
increasing the relevancy attribute weights of the plurality of attributes by a decay on positive feedback on the plurality of elements; and
finding a set of differing attributes and increasing the relevancy attribute weights of the set of differing attributes by a decay on substitution feedback on the plurality of elements.

2. The method of claim 1 further comprising:
storing the relevancy data back into the knowledge sources.

3. The method of claim 2 further comprising:
iterating the plurality of elements over the set of knowledges sources by:
creating a plurality of pairwise combinations of the plurality of elements,
selecting a pair and marking one as a source and the other as destination.

4. The method of claim 3 further comprising:
iterating the plurality of elements over the set of knowledges sources by:
finding a set of possible associations between the pair,
finding a set of additional associations by considering associative properties of a group ability and a hierarchy defined in a set of hierarchy properties of the plurality of elements, and
computing and tracking the relevancy and complimenting relevancy score on each pair of elements.

5. The method of claim 4 further comprising:
iterating the plurality of elements over the set of knowledges sources by:
finding a set of possible associations between each pair, and
reversing the association direction once the destination element.

6. The method of claim 5 further comprising:
determining the relevancy between the plurality of elements by:
extracting the matching attributes and relevancy weights defined from the plurality of elements from a set of different knowledge backings and the user of the system, wherein the different knowledge backings comprises one or more representations of the same element in different domains, and
applying relevancy technique defined for the particular type by utilizing the attribute weights.

7. The method of claim 6 further comprising:
determining the relevancy between the plurality of elements by:
storing the relevancy values,
applying a mathematical approach on determine the relevancy by extracting the relevancy value, and
storing the relevancy value.

8. The method of claim 7 further comprising:
removing noise from the grouping of the plurality of elements by:
collecting the relevancy values of the grouping, and
representing the plurality of relevancies into N-dimensional planes.

9. The method of claim 8 further comprising:
removing noise from the grouping of the plurality of elements by:
extracting properties from the structure obtained and iterating amongst different planes of relevancies of source & destination elements,
iteratively applying the filtering operation by increasing a subset of values and collecting a plurality of aggregations.

10. The method of claim 8 further comprising:
removing noise from the grouping of the plurality of elements by:
obtaining a statistical probability value of relevancy by comparing aggregations, and
utilizing technique of similarity.

11. The method of claim 10 further comprising:
performing a selection technique to select the top relevant elements in the grouping by applying methods of ranking, threshold inferred from historical aggregations or user imputed domain expertise.

12. The method of claim 1, wherein the domain information comprises a combination of image files and text files.

13. The method of claim 1, wherein the different knowledge backings are the representations of the same element in different domains.

14. The method of claim 13, wherein the different knowledge backings are used to determine the relevancy with respect to the user considering the various different types of knowledge representation in the head of different users.
